(19) United States
(12) Patent Application Publication
(10) Pub. No.: US 2026/0291352 A1
(43) Pub. Date: Sep. 24, 2026

(54) ARRANGING A WIRE WINDING IN A MAGNETIZABLE FLUX CONDUCTOR ELEMENT OF A STATOR OF A ROTARY ELECTRIC MACHINE DESIGNED AS A INTERNAL ROTOR

(71) Applicant: Innomotics GmbH, Nürnberg (DE)

(72) Inventors: Jaroslav Helstyn, Ostrava (CZ); Vladislav Josiek, Havirov (CZ); Klaus Kirchner, Ostheim (DE)

(73) Assignee: Innomotics GmbH, Nürnberg (DE)

(21) Appl. No.: 18/996,163

(22) PCT Filed: Jun. 30, 2023
(86) PCT No.: PCT/EP2023/067979

§ 371 Date: Jan. 17, 2025

(30) Foreign Application Priority Data
Jul. 22, 2022 (EP) 22186422.6

(51) Int. Cl. H02K 15/085; H02K 1/16; H02K 1/2706; H02K 3/12

(52) U.S. Cl. CPC H02K 15/085; H02K 1/16; H02K 1/2706; H02K 3/12

(57) ABSTRACT

A winding device for arranging a wire winding in a magnetizable flux conductor of a stator of a rotary electric machine embodied as an internal rotor, with the flux conductor element having a receiving opening for receiving a rotatably mounted rotor of the rotary electric machine and longitudinal grooves, open on the opening side, for arranging windings of the wire winding made of at least one winding wire, Includes a wire insertion device designed for arrangement at least partially in the receiving opening; and a supporting unit that supports insertion of the winding wire and has a guide element which is designed to arrange the winding wire in a predetermined longitudinal groove of the flux conductor element. The wire insertion device includes a carriage movable axially back and forth, on which a wire guiding sleeve is arranged and able to swivel between two predefinable swivel positions by a swivel drive.

The invention relates to a winding apparatus for arranging a wire winding in a magnetizable flux conductor of a stator of a rotary electric machine designed as an internal rotor, wherein the magnetizable flux conductor has a receiving opening for receiving a rotatably mounted rotor of the rotary electric machine and longitudinal grooves open on the opening side for arranging the wire winding, wherein the wire winding has windings made of at least one winding wire. The invention further relates to a method for arranging a wire winding in a magnetizable flux conductor of a stator of a rotary electric machine designed as an internal rotor, wherein the magnetizable flux conductor has a receiving opening for receiving a rotatably mounted rotor of the rotary electric machine and longitudinal grooves open on the opening side for arranging the wire winding, wherein the wire winding has windings made of at least one winding wire.

Generic electrical machines, stators for them and also methods and winding apparatuses for them are fundamentally known in the prior art, thus there is no need for written proof to be provided here. In a rotary electric machine, an armature is basically provided as a stator, which as a rule provides an essentially circular opening for receiving an armature embodied as a rotor. The rotor is arranged supported rotatably in the opening, wherein an air gap is embodied between the rotor and the stator.

A rotary electrical machine is an apparatus that converts electrical energy into mechanical energy, in particular kinetic energy (motor operation) and/or mechanical energy, into an electrical energy (generator mode). As rule the motion involves a rotating motion, which is carried out by the rotor. By contrast with the rotor, the stator is arranged so that it does not rotate, which means that the rotating motion involves a rotating movement of the rotor in relation to the stator. The stator and the rotor are linked by means of a magnetic flux, through which, in motor mode, the force effect, namely the torque, is created that drives the rotation of the rotor in relation to the stator, and in generator mode converts mechanical energy supplied to the rotor in the form of a rotation into electrical energy. For this purpose, at least the stator and possibly also the rotor have a winding through which an electrical current flows. In the stator or in the rotor the winding can also be formed or supplemented by a permanent magnet.

Rotary electrical machines of the generic kind are for example direct current machines, for example shunt or series machines, that, when operating as per specification, have a do electrical voltage or an electrical direct current applied to them, alternating current machines, to which an ac electrical voltage or an ac electrical current is applied, in particular polyphase machines, which are connected to a multi-phase, in particular three-phase, electrical alternating current network, such as for example asynchronous machines, synchronous machines, cage synchronous machines or the like.

The stator as a rule has at least a magnetizable flux conductor. The magnetizable flux conductor serves, during operation according to specification, to conduct a magnetic flux at least partly in order to achieve the desired machine function or at least to assist it. The magnetizable flux conductor can for example have a laminated core, which in its turn consists of individual ferromagnetic magnetizable sheets of metal electrically insulated from one another. The sheets, depending on their use, can also be referred to as dynamo sheets, motor sheets, transformer sheets or the like. Such sheets are subject to standardization, for example EN10106, EN10107 or the like. Let into the laminated core are grooves, which as rule are embodied as longitudinal grooves and which can essentially be embodied parallel to a longitudinal axis or axis of rotation of the rotor or also at an angle to said axis. Arranged in the longitudinal grooves are current-conducting winding wires of the winding, in particular of the stator winding, which provide a magnetic flux. The winding of the stator is thus frequently designed integrated into the laminated core.

The stator accepts the reaction in relation to a rotor torque and is supported against a support plate in order to be arranged so that it does not rotate. The support can be formed by a foundation or by the same support plate. The laminated core thus refers to a body structured in layers made from ferromagnetic materials and thus magnetizable, and indeed to the magnetizable flux conductor. The task of the magnetizable flux conductor, in conjunction with the winding through which the current is flowing, consists of bundling the magnetic flux. The magnetizable flux conductor can however also have a body made of a magnetizable ferrite material or the like.

The manufacturing of a stator winding for the rotary electrical machine as a rule comprises the winding, i.e. winding wires of the winding or of the stator winding, being arranged in through-openings provided for them, as a rule embodied as longitudinal grooves. In rotary electric machines in the low-power or medium-power range wire windings are frequently used that are formed from one or more winding wires, in particular round wires, which—by contrast with bar windings—can be pulled into the corresponding longitudinal grooves. Thus, for example, WO 2020/058048 A1 discloses the pulling of windings into a laminated stator core.

It is known for example for windings of the wire winding, in particular when they are made of a single electrical conductor in the form of a winding wire, in particular round wire or the like, to be wound onto a template and subsequently for the winding or the windings to be introduced into the longitudinal grooves. In the state arranged in the magnetizable flux conductor or in the stator, the winding has a winding head at axial ends of the stator or of the magnetizable flux conductor in each case. In the aforementioned method, a large number of the windings, as well as also sections that are assigned to one of the two winding heads, are as a rule unchecked outside of the template. During the pulling of the windings into the respective longitudinal grooves a predetermined arrangement of the individual windings cannot be guaranteed. Consequently, individual windings can cross over one another in the longitudinal grooves, through which a loss of the degree of filling in the respective longitudinal grooves can be produced. Through this for example, deviations in electrical voltages in relation to an adjacently arranged winding can occur in relation to a respective winding in normal operation. What is more there is the danger that binding insulation will be weakened or damaged.

WO 2020/058048 A1 on the other hand deals with being able to pull a so-called laid wire winding with a defined arrangement of the individual windings into the longitudinal grooves. To do this, inter alla a specific winding tool with tool grooves is employed, which are embodied on an outer circumference of a tool core and in which the individual windings of the wire winding are arranged.

Even if the prior art has proved to be fundamentally sound, disadvantages remain however. On the one hand the prior art methods prove to be complex and expensive, whereas on the other hand, in particular during use of the method using the template, the problem exists that the winding length of an individual winding has to be designed with an excess, so that in the following pulling-in process of the winding pulled in first, due to the winding length, It allows the last turn pulled in to be pulled completely into the longitudinal groove. Through this however an excess in relation to a winding length of the individual turns is needed, which can not only lead to electrical losses, but as a result also to a corresponding large embodiment of one of the respective winding heads. What is more, this can also have the effect of being disadvantageous for the stability of the winding heads in normal operation, because the individual windings are subjected to forces in each case.

The increasing demands on the efficiency of electrical machines and the changes associated therewith in the electromagnetic layout, such as for example how a groove is filled, a width of a groove opening and/or the like, widely used wire winding pulling-in methods are coming up against their technological limits. In the past the manufacturing of electrical machines has ever more been changed over to time-and cost-intensive manual winding. What is more, machine winding methods are being employed, such as for example a needle winding for small and medium machine sizes or a direct winding by means of robots for large electrical machines. These winding methods have specific disadvantages such as high investment in plant, a complex control through the overlaying of a number of directions of movement, whereby the result can be a reduction of the winding speed, as well as a need for spare parts, for example end disks for support and formation of winding heads, and/or the like.

The underlying object of the invention is to develop an inventive method to the extent that the manufacturing of the winding can be Improved and to specify a winding apparatus for doing so.

An apparatus and a method as claimed in the independent claims is proposed as the solution for doing this with the invention.

Advantageous developments are produced by the features of the dependent claims.

In relation to a generic apparatus, a winding apparatus for arranging a wire winding in a magnetizable flux conductor of a stator of a rotary electric machine embodied as an internal rotor is proposed with the invention, wherein the magnetizable flux conductor has a receiving opening for receiving a rotatably mounted rotor of the rotary electric machine and longitudinal grooves open on the opening side for arranging the wire winding, wherein the wire winding has windings made of at least one winding wire, with a wire insertion apparatus able to be arranged at least partly in the receiving opening and a supporting unit, which supports the insertion of the winding wire and has the at least one guide element, which is embodied to arrange the winding wire or the winding wires in a predefined longitudinal groove of the magnetizable flux conductor.

In relation to a generic method, a method for arranging a wire winding in a magnetizable flux conductor of a stator of a rotary electric machine embodied as an internal rotor is in particular proposed with the invention, wherein the magnetizable flux conductor has a receiving opening for receiving a rotatably mounted rotor of the rotary electric machine and longitudinal grooves open on the opening side for arranging the wire winding, wherein the wire winding windings consists of at least one winding wire, wherein a wire insertion apparatus is arranged at least partly in the receiving opening and the insertion of the winding wire is assisted by means of a supporting unit, which has at least one guide element, wherein the guide element arranges the winding wire or the winding wires in a predefined longitudinal groove of the magnetizable flux conductor.

The invention is based inter alia on the idea that the automated winding can be improved at least partly, as well as by the provision of a suitable wire insertion apparatus, which is preferably able to be arranged in the receiving opening, by a supporting unit, which for example through the use of for example wire guidance bodies, spring-tensioned components, additional drive units, and/or the like, can Improve the Introduction of the winding wire or the winding wires of the wire winding into the longitudinal grooves of the magnetizable flux conductor. This enables not only the effort for the, in particular automated, manufacturing of the stator winding or winding of the stator to be reduced, but also enables the quality of the winding to be improved. By means of the inventive winding apparatus or the inventive execution of the method effects on the respective winding turns arranged in the grooves of the winding can be reduced. In particular the accuracy of a positioning of a respective winding turn in a groove can be markedly improved. Inter alia, this also enables the filling of a groove to be improved, so that the fill factor can be increased.

At the same time a simple adaptation to different widths of groove in the circumferential direction can be achieved, so that the winding apparatus of the invention and also its method can be adapted in a simple way to very different stators or magnetizable flux conductors. This also enables the disadvantages with regard to large investments in plant and also the requirement with regard to additional parts to be reduced.

Thus, the inventive winding apparatus or inventive execution of the method enables wire windings—i.e. coils for example—regardless of the coil width to be set, Le. the predetermined space between the two longitudinal grooves in the circumferential direction, to be able to be positioned in their longitudinal grooves of a wide diversity of stator diameters.

The inventive winding apparatus or the inventive execution of the method of guiding the winding wire or the winding wires allows manufacturing of a wide diversity of winding systems in the laminated core of a stator, such as single-layer windings, double-layer windings, wave winding, lap winding, integral slot windings, fractional slot windings etc.

The Inventive winding apparatus or the inventive method of guiding the winding wire can also be employed for winding systems of segmented motors, in which the flux conductor is constructed segmented viewed in the circumferential direction. In this case first of all the individual segments are wound and if necessary impregnated and subsequently put together to form a stator closed in the circumferential direction.

The wire insertion apparatus can be embodied to be arranged, preferably concentrically to the longitudinal axis of the magnetizable flux conductor. The wire insertion apparatus is preferably embodied and driven in such a way that it is capable of arranging a respective coil of the wire winding, which can have a number of windings made of the at least one winding wire, In a pair of longitudinal grooves assigned in each case of the magnetizable flux conductor.

The wire insertion apparatus is further preferably embodied for arranging a number of coils in the longitudinal grooves made from a single winding wire. There can be provision for the wire insertion apparatus to provide two or more winding wires at the same time, in particular in parallel, for arrangement in the longitudinal grooves.

There can further be provision for the wire insertion apparatus to be embodied to arrange a number of part wire windings of the winding, separated electrically from one another in the longitudinal grooves. This is advantageous for example when the rotary electric machine involves an electrical machine for operation on a multiphase ac voltage. The wire insertion apparatus can be embodied to be able to arrange a number of windings of the winding wire in the same longitudinal groove.

The wire insertion apparatus preferably works together with the supporting unit, which supports the insertion of the winding wire. For this purpose, the supporting unit has at least one guide element, which is embodied to arrange the winding wire through explicit guidance in a predefined longitudinal groove of the magnetizable flux conductor. What this can achieve is that the wire insertion apparatus arranges the winding wire on the guide element, wherein the guide element acts on the wire due to a tension effect or a force effect, such as the force of a weight, in order to support or to make possible or to promote the arrangement of the winding wire in the respective longitudinal groove. To this end, the supporting unit can have a body element, which for example provides inclined surfaces, pins, combinations hereof or the like that, because of their alignment and position, can serve to enable to winding wire to slide into the respective longitudinal groove. For this purpose, the supporting unit can be arranged within the receiving opening. It does not need however to extend over the entire axial extent of the magnetizable flux conductor. Preferably there is provision however for the supporting unit to protrude from the receiving opening at least in part at one or both axial ends of the magnetizable flux conductor. The protruding sections of the supporting unit can be embodied in a suitable way in order to assist or to make possible the formation of a winding head.

The supporting unit can be arranged detachably on an inner surface of the receiving opening of the magnetizable flux conductor. Preferably it is arranged on the end face sides of the magnetizable flux conductor, in particular of the stator aligned to match edges of respective longitudinal grooves in the circumferential direction. The supporting unit can be embodied in one piece or in a number of pieces. There can however also be provision for the supporting unit to be arranged entirely outside the receiving opening of the magnetizable flux conductor, for example in the area of body end face sides embodied at axial ends of the magnetizable flux conductor. Here too corresponding guide elements can be provided. The guide elements can be embodied adapted in respect of the geometry of the magnetizable flux conductor to the longitudinal grooves provided by it and for example provide corresponding angled surfaces that assist or make possible the arrangement of the winding wire in the respective longitudinal grooves.

Since a predetermined number of windings of the winding wire are arranged in a groove or in a pair of grooves, there can be provision for the magnetizable flux conductor to be turned in relation to the winding apparatus in order accordingly to be able to wind a longitudinal groove or a further pair of longitudinal grooves. This can be continued successively until the winding of the magnetizable flux conductor is completely manufactured.

The use of the supporting unit for example enables a direction of movement in the guidance of the winding wire to be reduced or relocated. The use of the supporting unit can result in a reduction by one direction of movement during the actual winding process. This enables a simplification and a cost-saving variant of the winding apparatus to be achieved. The winding process as such can further be speeded up by the reducing overlaid movements. What is more, a high degree of flexibility in relation to variants of windings and magnetizable flux conductors can be achieved in a simple way. A smaller programming effort during adaptation to a magnetizable flux conductor to be rewound likewise proves advantageous. In this case for example, with a stator of an electrical machine, the following parameters, inter alia, are to be taken into account and set individually or in (part) total; axial length, outer diameter of the stator, diameter of the hole in the stator, number of grooves, groove depths, groove spacing of the longitudinal grooves for the windings.

A reduction of components on the product can further also be achieved by this.

For carrying out the wire winding process or the wire winding procedure the wire insertion apparatus can be held on the opposite ends of the magnetizable flux conductor. It proves especially advantageous however when the wire insertion apparatus is merely held on one end side. In this embodiment the magnetizable flux conductor can then be equipped with components in the winding apparatus or taken out of the winding apparatus in a simple way as soon as the winding is completed.

The longitudinal grooves forming a groove pair can be embodied in the circumferential direction with a predetermined spacing from one another. The supporting unit is preferably adapted to this. Likewise, the wire insertion apparatus can be adjusted accordingly to be able to arrange a coil of the winding in the groove pair of longitudinal grooves. For example, longitudinal grooves of a pair of grooves can be spaced apart from one another by an angle of around 50°. This can also vary however, depending on requirement, i.e. depending on the winding system of the stator planned for the project.

The inventive winding apparatus is consequently able to be used in a variety of ways, in particular for forming a wide diversity of windings.

It is further proposed that the supporting unit has a wire guide unit able to be arranged in the receiving opening at an edge of a longitudinal groove, which provides an angled surface as guide element, which is embodied to let a wire be inserted into the longitudinal groove by the wire insertion apparatus arranged on the angled surface. This enables the guiding of the winding wire into the longitudinal groove to be realized in a simple way without any further interventions being necessary. The angled surface can for example be embodied to correspond to the entire axial length of the longitudinal groove. Preferably the angled surface ends at an edge of the opening of the longitudinal groove. This enables the winding wire to slide unhindered into the longitudinal groove through the opening. The sliding for example be assisted or brought about by a tensile force on the winding wire. There can however also be provision for the winding wire to slide into in the longitudinal groove because of a weight force. In this case the longitudinal groove, in which the winding wire is to be arranged is preferably in a lower area of the magnetizable flux conductor.

What is more, it is proposed that the wire guidance unit has two opposing angled surfaces, which are spaced apart in the circumferential direction in such a way that a winding wire wound around the conductor element forms a winding turn of the winding and slides by means of the opposing angled surfaces into respective grooves of the longitudinal grooves. Preferably the angled surfaces are embodied for this so that they, when they rest against the respective edges of the groove, are inclined opposite to one another, so that a tensile force on the winding wire makes it possible for them to slide into the two longitudinal grooves. The wire guidance unit thus determines by its positioning in relation to the longitudinal grooves forming a pair of grooves, the arrangement of the winding in the longitudinal grooves. As soon as a coil made of a number of windings has been manufactured in this way, the wire guidance unit and/or the magnetizable flux conductor can be turned in relation to one another, so that the winding can be continued with a further pair of grooves. Then a corresponding further coil can be manufactured according to the aforementioned method.

The opposite angled surfaces of the wire guidance unit have an angled position for example, which can be embodied essentially constant in the axial direction. Preferably the spacing between the opposite angled surfaces is smaller in the areas of the edges of the grooves than radially at a distance from this in the direction towards the longitudinal axis. This enables a corresponding guidance of the winding wires into the longitudinal grooves to be assisted.

It is furthermore proposed that the wire guidance unit has end areas at its opposite axial ends in each case, which protrude beyond end face sides embodied at axial ends of the magnetizable flux conductor body and form a respective radial angled section, which rests with one end against the end face side of the body. The end resting against the end face side of the body is thus radially outside an area of the receiving opening. This enables the formation of a winding head to be supported, so that a separate tool for forming the winding head is saved or the effort for this can be reduced. The angled sections can likewise be formed by an angled surface. What is more the angled section can however also be formed by one or more pins protruding radially outwards, which are by the respective axial ends of the wire guidance unit at least partly directed angled outwards towards the end face side of the body. Thus, through a weight force or a tension on the winding wire, a corresponding movement can be obtained, so that the winding wire in the area of the end face side of the body is pulled radially outwards. The pins are preferably movable. In particular the pins can serve as a guidance apparatus for the at least one winding wire. They can be driven by means of a pin drive unit, in order for example to enable a position and/or an alignment to be set. Especially advantageously the pins can be retracted after a coil of the winding has been completed. Through this it is possible for the winding end to be released in order to turn the stator or the magnetizable flux conductor in order to make winding with a further coil of the winding possible.

It is furthermore proposed that a wire guide element supported so as to be able to be moved, in particular able to be swiveled, is arranged in the area of the angled sections, which is embodied, to be moved, in particular swiveled, by means of a drive unit between and idle position and an assist position. The wire guide element can preferably be moved radially outwards or swiveled so that it can assist the formation of the winding head. For this purpose, there can be provision for the wire guide element to be able to be driven by means of the drive unit. For example, there can be provision for the wire guide element to be actuated each timer that a winding wire is arranged on the angled sections, in order to move or to deform the winding wire into the desire position for the winding head. In the idle position there can be provision for the wire guide element essentially not to act on the winding wire. Through this for example the winding process by means of the wire insertion apparatus can be assisted or it can be achieved that this process is not disrupted. The assistance position is then preferably a position, in particular a swivel position, in which the winding wire is moved Into the desired position. This is especially advantageous when the winding wire, due to its mechanical properties, does not assume the desired position by itself.

What is more it is proposed that the winding apparatus has a forming tool able to be arranged in the area of a winding head to be embodied, which is able to be moved by means of a tool drive unit axially parallel to the longitudinal axis. The forming tool, for arranging the winding wire on the angled section, is preferably arranged at a distance from the wire guidance. This enables the arrangement of the winding wire by the wire insertion apparatus to take places largely undisturbed. The forming tool preferably accordingly has a form adapted to the winding head to be embodied. By actuating the tool drive unit linked mechanically to the forming tool the forming tool can be moved axially parallel to the longitudinal axis, so that it can act mechanically on the ends of the winding forming the winding head. This enables the ends of the winding to be deformed to embody the winding head. This is preferably undertaken when all ends of the winding are already arranged in the area of the end face side of the body. As an alternative however there can also be provision for the forming tool even to be actuated accordingly during each arrangement of individual windings.

In accordance with one development, it is proposed that the wire insertion apparatus has a carriage able to be moved back and forth axially, on which a wire guiding sleeve is arranged, which is embodied to be swiveled by means of swivel drive between two predeterminable swivel positions. Through this it is possible in a simple way, by means of the wire insertion apparatus to insert the wire accordingly into predetermined grooves, in particular predetermined longitudinal grooves of a pair of grooves. There can be provision for the winding wire in a forwards movement into a swivel position, to be inserted into a first of the longitudinal grooves, and after reaching an axial end of the longitudinal groove, for the wire guiding sleeve to be swiveled to a predetermined second of the longitudinal grooves, to indeed be moved in a circumferential direction about the longitudinal axis, so that the winding wire, when the carriage moves back, is laid in the other of the longitudinal grooves. This process can be repeated until such time as the desired number of windings is arranged in the pair of longitudinal grooves. Thereafter the magnetizable flux conductor can be turned accordingly, so that a further pair of von longitudinal grooves can be wound accordingly.

The wire guiding sleeve has exchangeable inserts in order to be able to process a number of winding wires in parallel.

Furthermore, this also makes it possible not only to process round wires with a predeterminable cross section with the apparatus in the magnetizable flux conductor, but also to use different cross sections and/or cross-sectional shapes of the winding wires.

A dynamoelectric machine manufactured by the inventive winding apparatus and/or the inventive method thus has a comparatively axially short winding head, and a higher winding fill level of the winding (for example round wire winding) in the grooves of the dynamoelectric machine. This means that a higher efficiency is obtained by comparison with comparable dynamoelectric machines, which above all comes into effect as a drive for boosters, pumps, compressors, fans, conveyor belts etc., in the industrial environment, in the foodstuffs industry, in the medical sector and in vehicles—road vehicles or rail vehicles.

The advantages and effects specified for the inventive method naturally also apply equally for the inventive winding apparatus and vice versa. To this extent apparatus features can also be formulated as method features and vice versa.

The exemplary embodiments explained below involve preferred forms of embodiment of the invention. The features, combinations of features specified above and also the features and combinations of features given below in the description of exemplary embodiments and/or in the figures alone, are not only able to be used in the combination, but also in other combinations specified in each case. Thus, versions of the invention are also included or to be seen as disclosed that are not shown and explained explicitly in the figures, but which arise and are able to be created from separated combinations of features of the forms of embodiment explained. The features, functions and/or effects shown with the aid of the exemplary embodiments shown can, taken by themselves, each represent individual features, functions and/or effects of the invention to be considered independently of one another, which also each develop the invention Independently of one another. Therefore, the exemplary embodiments are also to include combinations other than those in the explained forms of embodiment. What is more, the described forms of embodiment can also be supplemented by further of the features, functions and/or effects of the invention already described.

In the figures the same reference characters designate the same features and functions.

It is shown in:

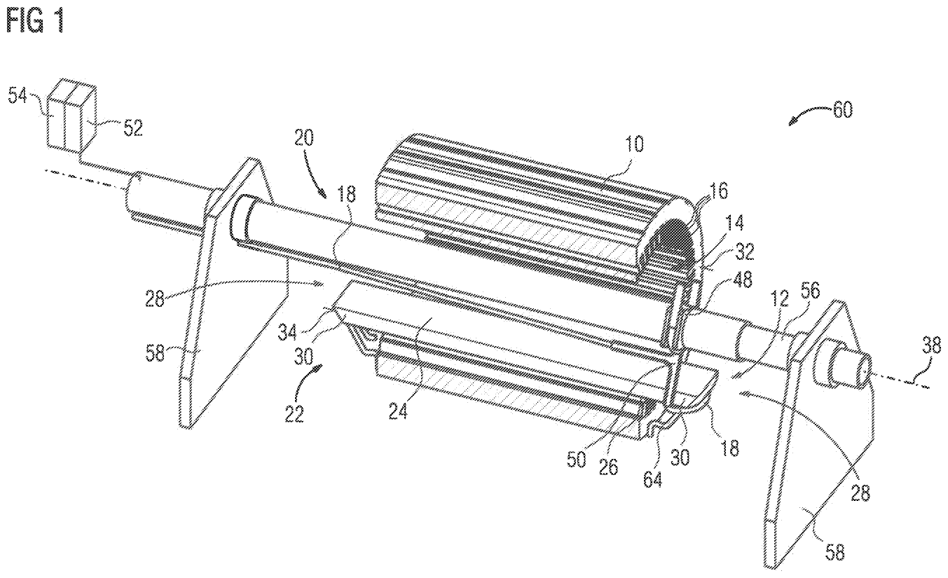

FIG. 1 a schematic perspective view of a first embodiment of a winding apparatus;

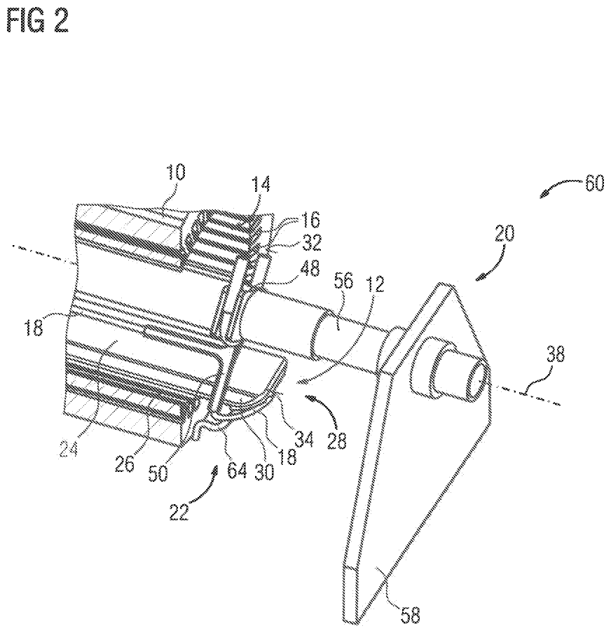

FIG. 2 a schematic perspective view of a section of the first embodiment of the winding apparatus in accordance with FIG. 1;

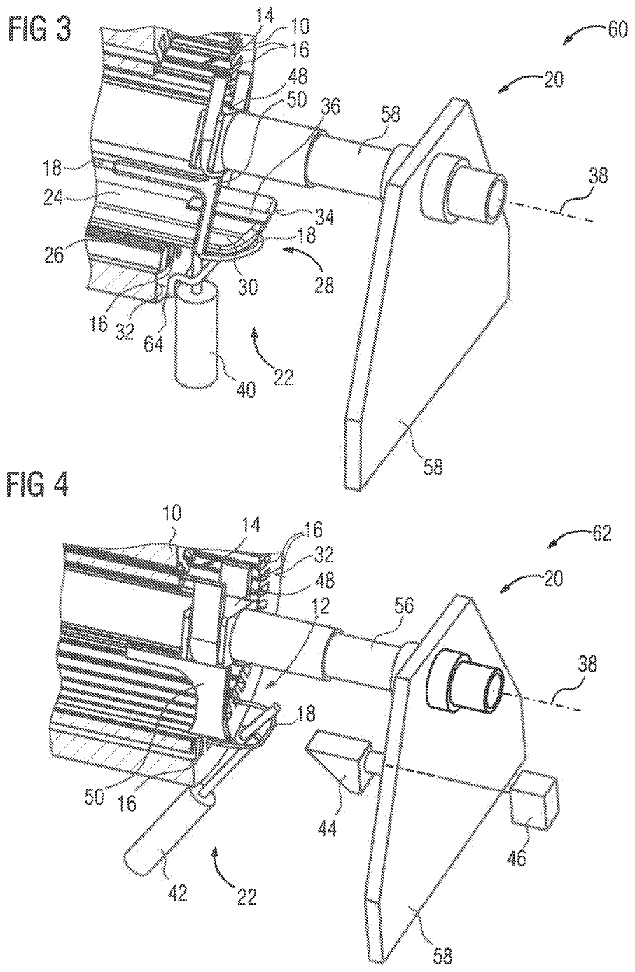

FIG. 3 a schematic perspective view like FIG. 2 of a second embodiment of a winding apparatus; and

FIG. 4 a schematic perspective view of a third embodiment of a winding apparatus.

FIG. 1, in a schematic perspective view, shows a winding apparatus 60, which serves to arrange a wire winding 12 in a laminated core 10 of a stator of a rotary electric machine embodied as an internal rotor. The stator as well as the further elements of the rotary electric machine thus embodied are not shown in the FIG.

The laminated core 10 serves in the present example as a magnetizable flux conductor. In the present example the laminated core 10 has an essentially circular cross section-shaped receiving opening 14 for receiving the rotatably supported rotor of the rotary electric machine. The laminated core 10 has open longitudinal grooves 16 at is opening side in relation to the receiving opening 14 for arranging the wire winding 12. In the present example the wire winding 12 is formed by windings made of a winding wire 18. The receiving opening 14 has a longitudinal axis 38.

The laminated core 10 has axial body ends on which body end face sides 32 are embodied. The longitudinal grooves 16 are embodied open on the body end face sides 32, so that the winding wire 18 can protrude axially from the longitudinal grooves 16.

The winding apparatus 60 has a wire insertion apparatus 20 able to be arranged in the receiving opening 14. The wire insertion apparatus 20 has a carriage 48 able to be moved back and forth axially. For this purpose, a corresponding carriage drive unit 54 is provided, which accordingly drives the carriage 48 mechanically.

Arranged on the carriage 48 is a wire guiding sleeve 50, which is embodied, by means of a swivel drive 52, to be swiveled between two predetermined swivel positions. For this purpose, the swivel drive 52 is likewise mechanically connected to the carriage 48. The tool drive unit 46 as well as the swivel drive 52 can actually be embodied in one piece in a common unit. Preferably however they are also designed as separate units. By means of the swivel drive 52 the swivel positions are changed in each case at the axial end positions of the carriage 48 move back and forth. In the present example there is no provision for the changing of the swivel positions to be carried out during the back-and-forth movements of the carriage 48. The winding wire 18 is routed in the present example through the wire guiding sleeve 50, so that the arrangement of the winding wires 18 can be brought about by the wire guiding sleeve 50.

In the present example the carriage 48 is held movably on a retaining axis 56. The retaining axis 56 is held at opposite ends of respective retaining units 58 coaxially to the longitudinal axis 38. In alternative embodiments there can also be provision for just a single retaining unit 58 to be present, so that the laminated core 10 can be connected in a simple way to the winding apparatus 60 without a retaining unit 58 needing to be mounted. In the present example a longitudinal axis of the retaining unit 58 is arranged coaxially to the longitudinal axis 38. The retaining axis 56 does not need to be arranged coaxially, however. It can also just be arranged parallel to the longitudinal axis.

Not shown in the FIGS. is a wire provision apparatus, which feeds and provides the winding wire 18 to the winding apparatus 60 In a suitable way. The winding wire 18 is routed through the wire guiding sleeve 50 and is provided by said sleeve in a suitable way, as will be described below, for arrangement in the respective longitudinal groove 16.

As FIGS. 1 and 2 show, the winding apparatus 60 further has a supporting unit 22, which supports the insertion of the winding wire 18 and which has a guide element for this, which is embodied to arrange the winding wire 18 in the predetermined longitudinal groove 16 of the laminated core 10. For this purpose, the supporting unit 22 in the present embodiment has a wire guidance unit 24 able to be arranged in the receiving opening 14 on one edge of the predetermined longitudinal groove 16. The wire guidance unit 24 provides an angled surface 26 that serves as the guide element. The angled surface 26 is embodied to allow a winding wire 18 arranged by the wire insertion apparatus 20 on the angled surface 26 of a winding winding 12 to slide into the longitudinal groove 16. For this purpose, a radial outer end of the angled surface 26 is embodied on an edge of the corresponding longitudinal groove 16. In the present example the angled surface 26 is embodied in the axial direction corresponding to the extent of the laminated core 10. This means that a corresponding guidance effect can be achieved over the entire axial length of longitudinal groove 16.

In the present embodiment there is provision for the wire guidance unit 24 to have two opposite angled surfaces 26, of which only one of the two angled surfaces 26 can be seen in FIG. 1. The second, opposite angled surface likewise extends in the In axial direction like the visible angled surface 26. The non-visible angled surface 26 is likewise arranged accordingly in relation to a longitudinal groove 16, so that it supports the winding wire 18 sliding into this longitudinal groove 16 or makes this possible. The two angled surfaces 26 are spaced apart in a circumferential direction in such a way that a winding wire 18 of the wire winding 12 wound around the wire guidance unit 24 is embodied and slides by means of the opposite angled surfaces 26 into respective of the longitudinal grooves 16. In this way a corresponding coil can be embodied in respective longitudinal grooves 16.

For this purpose, the wire insertion apparatus 20 is driven accordingly, so that the accordingly windings of the coil of the winding 12 are arranged on the wire guidance unit 24 one after another and are arranged in the corresponding longitudinal grooves 16. In the present embodiment these two longitudinal grooves 16 form a pair of grooves, which serve to form a corresponding coil of the winding 12. The longitudinal grooves aced apart from one another in the present example by an angle of around 50° in the circumferential direction. Depending on the construction of the rotary electric machine and of the winding 12, a different value for this angle can also be chosen. The longitudinal grooves 16 arranged between the pair of grooves arranged are reached by the wire guidance unit 24 through the reliable winding functionality of the winding apparatus 60.

It can further be seen from FIG. 1 und 2 that the wire guidance unit 24 is embodied, in the state arranged in the receiving opening 14, to form two opposite end areas 28, which serve to embody a winding head. In the end areas 28 the winding wire 18 is transferred from a respective first longitudinal groove 16 to a respective second longitudinal groove 16 in the area of the body end face side 32. Thereby respective winding ends not Indicated in the figure are embodied, which are used for the later formation of the respective winding head.

The end areas 30 protrude beyond the body end face sides 32 from the receiving opening 14 and form a respective radial angled element 34, which rests with one end on the body end face side 32. The angled elements 34 thus extend radially outwards from the wire guidance unit 24. Through the angled elements 34 the winding ends of the winding wires 18 are guided radially outwards, so that they can form the winding head and at the same access to the receiving opening 14 remains free. To this end the wire guidance unit 24 has respective end areas 30 at its opposite axial ends.

The angled elements 34 in the present example are supplemented at least in part by pin-like extensions 64. These serve to assist the arrangement of the winding wire 18 in the respective longitudinal groove 16 and at the same time to move the winding wire 18 radially outwards outside of the laminated core 10. For assistance there can be provision for the wire guiding sleeve 50 to be embodied to exert a tensile force on the winding wire 18, so that a corresponding movement of the winding wire 18 on the angled element 34 can be assisted (FIG. 2).

FIG. 3, in a schematic perspective view like FIG. 2, shows a second embodiment of the winding apparatus 60, which is based on the first embodiment of FIGS. 1 and 2, which is why the reader is referred to these two versions for more information. Only the differences therefrom are explained below.

It can be seen from FIG. 3 that the wire guidance unit 24 in this embodiment has a movably supported wire guide element 36 in the area of the angled elements 34, which is embodied to be moved by means of a drive unit 40 between an idle position and an assistance position, Shown in FIG. 3 is the idle position in which the wire guide element 36 essentially does not act on the guidance of the winding wire 18. The drive unit 40 can for example be embodied as a lifting magnet. As an alternative however a hydraulic or pneumatic control or a ball screw or the like can be provided.

In the present example the wire guide element 36 is able to be moved radially downwards. For this purpose, it is driven accordingly by means of the drive unit 40, so that the assistance position can be assumed. In the assistance position the wire guide element 36 is moved radially downwards and can thereby act on the winding wire 18 in the area of the winding end and thus assist the formation of the winding head, as already explained previously. The actuation of the drive unit 40 can be provided separately for each individual winding of the winding wire 18. There can however also be provision for the drive unit 40 only to be actuated after arrangement of a predetermined number of windings, so that the winding ends of the winding wire 18 can be moved jointly into the desired position.

FIG. 4 shows a third embodiment for a winding apparatus 62, which is based in part on the preceding embodiments in accordance with FIGS. 1 to 3, whereby the reader is referred to these versions for more information. As can be seen from FIG. 4, the winding apparatus 62 is intended not just to process a single winding wire 18 in one step, but two or more winding wires 18 at the same time, which in the present example are processed in parallel. For this purpose, the wire guiding sleeve 50 is embodied accordingly, so that it is capable of guiding two winding wires 18 jointly.

To do this, the wire guiding sleeve 50 has exchangeable inserts to enable it to process a number of winding wires 18 in parallel.

Furthermore, it is also possibly thereby to process not only round wires with a predeterminable cross-section by means of the apparatus in the laminated core 10 of the stator, but also to use different cross sections and/or cross-section shapes of the winding wires 18.

In a further difference from the preceding exemplary embodiments, the supporting unit 22 here has no wire guidance unit 24, but Instead at one of the respective end face sides 32 has two pins 42 arranged spaced apart from one another and inclined relative to the longitudinal axis 38. in the present example and also in general the pins are connected to a pin drive unit, which allows the pins 42, after completion of a respective coil, to be withdrawn from the winding wires 18. What can be achieved by this is that the stator or the laminated core 10 can be turned to the pair of longitudinal grooves 16 to be fabricated next.

The pins 42 are embodied to be adjustable in respect of their inclination and their position, so that in a simple way an adaptation to a wide variety of laminated cores 10 is possible. The pins 42 serve to make it possible, in the area of the axial body end face sides 32 to guide the winding wires 18 from a respective first longitudinal groove 16 to a second longitudinal groove 16 spaced apart from it in each case. At the same time the inclined position enables it to be achieved in relation to the longitudinal axis 38 that, during arrangement of the winding wires 18, due to a tensile force, the winding wires 18 are moved radially outwards in the area of the pins 42 in order later to embody the winding head.

In the present example the wire guiding sleeve 50 is embodied so that the winding wires 18 can be directly introduced by said unit into the longitudinal grooves 16. To do this, the respective swivel position of the wire guiding sleeve 50 is accordingly controlled precisely. The basic principle of the carriage 48 as well as of the wire guiding sleeve 50 corresponds to that that which has already been explained, which is why the reader is referred to the remarks made in this regard.

In this embodiment there is further provision for the winding apparatus 62 to have a forming tool 44 arranged in the area of a winding head to be embodied. The forming tool 44 is able to be moved axially parallel to the longitudinal axis 38 and is driven accordingly by means of a tool drive unit 46. The forming tool 44 serves to support the winding fires 18 during the radially outwards movement in the area of the body end face sides 32. This enables the embodiment of the winding head to be achieved or at least assisted in a simple way. Here too there can naturally be provision for the forming tool 44 only to be actuated when a respective coil of the winding 12 has been completely wound. There can however also be provision for the forming tool already to be actuated after the production of a respective winding.

The laminated core 10 is shown in section in the FIGS. For the person skilled in the art, it is clear however that the laminated core 10 is embodied closed in the circumferential direction. The cutaway view serves merely to explain the invention.

The exemplary embodiments serve exclusively to explain the invention and are not intended to restrict said invention.

1.-13. (canceled)

14. A winding apparatus for arranging a wire winding in a magnetizable flux conductor of a stator of a rotary electric machine embodied as an internal rotor, the winding apparatus comprising:
a wire insertion apparatus designed for arrangement at least in part in a receiving opening of the magnetizable flux conductor for receiving a rotatably mounted rotor of the rotary electric machine, said wire insertion apparatus comprising a carriage designed for axial movement back and forth;
a wire guiding sleeve arranged on the carriage;
a swivel drive designed to swivel the wire guiding sleeve between two predefinable swivel positions;
a supporting unit designed to assist insertion of a winding wire as winding of a wire winding and comprising a guide element designed to arrange the winding wire in a predetermined one of longitudinal grooves of the magnetizable flux conductor, which are open on an opening side;
a wire guidance unit having at its opposite axial ends end areas which protrude beyond body end face sides embodied at axial body ends of the magnetizable flux conductor and form radial angled elements, respectively, which rest with one end against the body end face sides, respectively;
a forming tool designed for arrangement in an area of a winding head to be formed, with the forming tool having a form which is adapted to the winding head to be formed; and
a tool drive unit linked mechanically to the forming tool to move the forming tool axially parallel to a longitudinal axis defined by the receiving opening of the magnetizable flux conductor such that the forming tool is able to act mechanically on ends of the winding forming the winding head, thereby enabling the ends of the winding to be deformed to form the winding head, when all ends of the winding are already arranged in an area of an end face side of the magnetizable flux conductor.

15. The winding apparatus of claim 14, wherein the supporting unit comprises the wire guidance unit arranged in the receiving opening at an edge of the longitudinal groove and provides an angled surface which forms the guide element and is designed to let the winding wire arranged by the wire insertion apparatus on the angled surface of a winding slide into the longitudinal groove.

16. The winding apparatus of claim 15, wherein the wire guidance unit includes two of said angled surface lying opposite one another and spaced apart from one another in a circumferential direction in such a way that a winding wire wound around the wire guidance unit forms a winding of the wire winding, with the angled surfaces sliding into a respective one of the longitudinal grooves.

17. The winding apparatus of claim 14, wherein the wire guidance unit includes an end area for forming the winding head, when the wire guidance unit is arranged in the receiving opening.

18. The winding apparatus of claim 14, wherein the wire guidance unit comprises a movably supported wire guide element arranged in an area of the angled elements and designed for movement by a drive unit between an idle position and an assistance position.

19. The winding apparatus of claim 14, wherein the supporting unit comprises on at least one of the body end face sides two pins which are arranged spaced apart from one another and inclined in relation to the longitudinal axis, said pins being designed, in relation to the magnetizable flux conductor to extend radially from outside to inside at least into an area of the longitudinal grooves in order to assist formation of the winding head.

20. The winding apparatus of claim 19, wherein the pins are movable.

21. The winding apparatus of claim 14, wherein the wire guiding sleeve comprises exchangeable inserts in order to be able to process both a number of parallel processable winding wires and/or a cross section of the winding wires and also cross-sectional shapes of the winding wires.

22. A method for arranging a wire winding in a magnetizable flux conductor of a stator of a rotary electric machine embodied as an internal rotor, wherein the magnetizable flux conductor has a receiving opening for receiving a rotatably mounted rotor of the rotary electric machine and longitudinal grooves open on an opening side for arranging the wire winding, wherein the wire winding has windings made of at least one winding wire, the method comprising:
arranging a wire insertion apparatus at least partly in the receiving opening;
assisting insertion of the winding wire by a supporting unit which includes a guide element to arrange the winding wire in a predetermined one of the longitudinal grooves of the magnetizable flux conductor;
arranging a wire guiding sleeve on an axially back-and-forth movable carriage of the wire insertion apparatus for swiveling by a swivel drive between two predetermined swivel positions in order to position the windings in the respective grooves,
arranging a forming tool in an area of a winding head to be formed; with the forming tool having a form adapted to the winding head;
linking mechanically a tool drive unit to the forming tool for movement of the forming tool axially parallel to a longitudinal axis defined by the receiving opening so that the forming tool is able to actuate mechanically on ends of the winding forming the winding head, thereby enabling the ends of the winding to be deformed to form the winding head, when all ends of the winding are already arranged in thane area of end face side of the magnetizable flux conductor, and
forming end areas of a wire guidance unit at opposite ends of the wire guidance unit to protrude at axial ends of body end face sides of the magnetizable flux conductor so as to form radial angled elements, respectively, which rest with one end against the body end face sides, respectively.

23. The method of claim 22, further comprising positioning the winding wire under tension.

24. A dynamoelectric machine manufactured by the winding apparatus as set forth in claim 14.

25. The dynamoelectric machine of claim 24 for use as a drive for a booster, pump, compressor, or fan, in an industrial environment, in foodstuffs industry, or medical sector.

26. A dynamoelectric machine manufactured by the method as set forth in claim 22.

27. The dynamoelectric machine of claim 26 for use as a drive for a booster, pump, compressor, or fan, in an industrial environment, in foodstuffs industry, or medical sector.
